(19) United States
(12) Patent Application Publication
(10) Pub. No.: US 2026/0128010 A1
(43) Pub. Date: May 7, 2026

(54) DISPLAY DEVICE AND ELECTRONIC DEVICE INCLUDING SAME

(71) Applicant: Samsung Display Co., Ltd., Yongin-si (KR)

(72) Inventors: Byung Chul KIM, Yongin-si (KR); Sang Myoung LEE, Yongin-si (KR); Oh Chul KWON, Yongin-si (KR); Byung Kwan SONG, Yongin-si (KR); Ki Myeong EOM, Yongin-si (KR); Jae Hoon LEE, Yongin-si (KR); Ki Seok CHA, Yongin-si (KR); Sang Hyun KANG, Yongin-si (KR); Pan Ju KIM, Yongin-si (KR); Joon HUH, Yongin-si (KR)

(21) Appl. No.: 19/370,558

(22) Filed: Oct. 27, 2025

(30) Foreign Application Priority Data
Nov. 4, 2024 (KR) 10-2024-0154533

(51) Int. Cl. G09G 3/3233; G09G 3/3266

(52) U.S. Cl. CPC G09G 3/3233; G09G 3/3266; G09G 2300/0819; G09G 2300/0852; G09G 2300/0861; G09G 2310/08; G09G 2320/0233; G09G 2330/021

(57) ABSTRACT

A display device includes: a sub-pixel connected to a data line, a first sub-light emission control line, a first sub-gate line, and a second sub-gate line, and including a light-emitting element; a gate driver configured to supply a first sub-light emission control signal to the first sub-light emitting control line, to supply a first sub-gate signal to the first sub-gate line, and supply a second sub-gate signal to the second sub-gate line; and a data driver configured to supply a data voltage to the data line, wherein a length of a period in which the second sub-gate signal is supplied during a display scan period is different from a length of a period in which the second sub-gate signal is supplied during a self-scan period; and wherein the second sub-gate signal is provided to control a time at which an electrode of the light-emitting element is initialized.

### CROSS-REFERENCE TO RELATED APPLICATION

The present application claims priority to and the benefit of Korean Patent Application No. 10-2024-0154533, filed on Nov. 4, 2024, in the Korean Intellectual Property Office, the entire disclosure of which is incorporated herein by reference.

### BACKGROUND

### 1. Field

Aspects of some embodiments of the present disclosure relate to a display device and an electronic device including the same.

### 2. Description of the Related Art

With the development of information technology, the importance of display devices, which provide a connection medium between users and information, are being highlighted. Accordingly, the use of display devices such as liquid crystal display devices and organic light emitting display devices is increasing.

Display devices may include a plurality of pixels. A pixel column may be connected to the same data line. In this case, when the data voltage changes rapidly, it may affect other pixel rows in which the data voltage is not written. This may cause unintended image such as mura to be visually recognized in some areas of the display panel.

The above information disclosed in this Background section is only for enhancement of understanding of the background and therefore the information discussed in this Background section does not necessarily constitute prior art.

### SUMMARY

Aspects of some embodiments of the present disclosure include a display device that minimizes or reduces stains and an electronic device including the same.

According to some embodiments of the present disclosure, the display device includes: a sub-pixel connected to a data line, a first sub-light emission control line, a first sub-gate line, and a second sub-gate line, and including a light-emitting element; a gate driver to supply a first sub-light emission control signal to the first sub-light emitting control line, supply a first sub-gate signal to the first sub-gate line, and supply a second sub-gate signal to the second sub-gate line; and a data driver to supply a data voltage to the data line. A length of a period in which the second sub-gate signal is supplied during a display scan period is different from a length of a period in which the second sub-gate signal is supplied during a self-scan period. The second sub-gate signal is provided to control a time at which an electrode of the light-emitting element is initialized.

According to some embodiments, the sub-pixel may include: a first transistor to control driving current, the first transistor coupled between a first node which receives a first power supply voltage and a second node and including a gate electrode coupled to a third node; a second transistor connected between the data line and the third node and including a gate electrode connected to the first sub-gate line; a third transistor connected between the second node and a fourth node, and including a gate electrode connected to the first sub-light emission control line; and a fourth transistor connected between a node which provides an initialization voltage and the fourth node, and including a gate electrode connected to the second sub-gate line. According to some embodiments, the light-emitting element may be connected between the fourth node and a node which receives a second power supply voltage.

According to some embodiments, the data voltage may be written to the sub-pixel during the display scan period, and the data voltage may not be written to the sub-pixel during the self-scan period.

According to some embodiments, during the display scan period, the gate driver may supply the second sub-gate signal for a first period. During the self-scan period, the gate driver may supply the second sub-gate signal for a second period.

According to some embodiments, a length of the first period may be longer than a length of the second period.

According to some embodiments, a length between an end time of a non-emission period including the first period and an end time of the first period may be the same as a length between an end time of a non-emission period including the second period and an end time of the second period.

According to some embodiments, a length between a start time of the non-emission period including the first period and a start time of the first period may be shorter than a length between a start time of the non-emission period including the second period and a start time of the second period.

According to some embodiments, a length of the first period may be shorter than a length of the second period.

According to some embodiments, a length between an end time of a non-emission period including the first period and an end time of the first period may be the same as a length between an end time of a non-emission period including the second period and an end time of the second period.

According to some embodiments, a length between a start time of the non-emission period including the first period and a start time of the first period may be longer than a length between a start time of the non-emission period including the second period and a start time of the second period.

According to some embodiments, the sub-pixel may further include: a fifth transistor connected between a node which receives the first power supply voltage and the first node, and including a gate electrode connected to a second sub-light emission control line; and a sixth transistor connected between a node which receives a reference voltage and the third node, and including a gate electrode connected to a third sub-gate line. According to some embodiments, the gate driver may supply a second sub-light emission control signal to the second sub-light emitting control line, and may supply a third sub-gate signal to the third sub-gate line.

According to some embodiments of the present disclosure, the display device includes: a sub-pixel connected to a data line, a first sub-light emission control line, a first sub-gate line, and a second sub-gate line and including a light-emitting element; a gate driver to supply a first sub-light emission control signal to the first sub-light emitting control line, supply a first sub-gate signal to the first sub-gate line, and supply a second sub-gate signal to the second sub-gate line; and a data driver to supply a data voltage to the data line. According to some embodiments, a number of times that the second sub-gate signal is supplied during a display scan period is different from a number of times the second sub-gate signal is supplied during the self-scan period. According to some embodiments, the second sub-gate signal is provided to control a time at which an electrode of the light-emitting element is initialized.

According to some embodiments, the sub-pixel may include: a first transistor to control driving current, the first transistor coupled between a first node which receives a first power supply voltage and a second node and including a gate electrode coupled to a third node; a second transistor connected between the data line and the third node, and including a gate electrode connected to the first sub-gate line; a third transistor connected between the second node and a fourth node, the third transistor including a gate electrode connected to the first sub-light emission control line; and a fourth transistor connected between a node which provides an initialization voltage and the fourth node, the fourth transistor including a gate electrode connected to the second sub-gate line. According to some embodiments, the light-emitting element may be connected between the fourth node and a node which receives a second power supply voltage.

According to some embodiments, the data voltage may be written to the sub-pixel during the display scan period, and the data voltage may not be written to the sub-pixel during the self-scan period.

According to some embodiments, a number of times the gate driver supplies the second sub-gate signal during the display scan period may be less than a number of times the gate driver supplies the second sub-gate signal during the self-scan period.

According to some embodiments, a number of toggles of the second sub-gate signal during the display scan period may be less than a number of toggles of the second sub-gate signal during the self-scan period.

According to some embodiments, a number of toggles may be a number of times a logic level of the second sub-gate signal changes.

According to some embodiments, a number of times the gate driver supplies the second sub-gate signal during the display scan period may be greater than a number of times the gate driver supplies the second sub-gate signal during the self-scan period.

According to some embodiments, a number of toggles of the second sub-gate signal during the display scan period may be greater than a number of toggles of the second sub-gate signal during the self-scan period.

According to some embodiments, the sub-pixel may further include: a fifth transistor connected between a node which receives the first power supply voltage and the first node, and including a gate electrode connected to a second sub-light emission control line; and a sixth transistor connected between a node which receives a reference voltage and the third node, and including a gate electrode connected to a third sub-gate line. According to some embodiments, the gate driver may supply a second sub-light emission control signal to the second sub-light emitting control line, and may supply a third sub-gate signal to the third sub-gate line.

According to some embodiments of the present disclosure, an electronic device includes: a processor; and a display device including pixels, and configured to display an image in the pixels under a control of the processor. According to some embodiments, the display device includes: a sub-pixel connected to a data line, a first sub-light emission control line, a first sub-gate line, and a second sub-gate line, and including a light-emitting element; a gate driver to supply a first sub-light emission control signal to the first sub-light emitting control line, supply a first sub-gate signal to the first sub-gate line, and supply a second sub-gate signal to the second sub-gate line; and a data driver to supply a data voltage to the data line. A length of a period in which the second sub-gate signal is supplied during a display scan period is different from a length of a period in which the second sub-gate signal is supplied during a self-scan period. The second sub-gate signal is provided to control a time at which an electrode of the light-emitting element is initialized.

### BRIEF DESCRIPTION OF THE DRAWINGS

FIG. 1 is a block diagram illustrating aspects of a display device.

FIG. 2 is a block diagram illustrating aspects of any one of the sub-pixels of FIG. 1.

FIG. 3 is a circuit diagram illustrating aspects of the sub-pixel in FIG. 2.

FIG. 4 is a conceptual diagram illustrating a driving operation of the display device of FIG. 1.

FIG. 5 is a timing diagram illustrating an example in which the display device of FIG. 1 performs a display scan operation.

FIG. 6 is a timing diagram illustrating an example in which the display device of FIG. 1 performs a self-scan operation.

FIG. 7 is a diagram for illustrating a phenomenon in which a pattern displayed in a partial area of a display panel is copied and expressed in another area.

FIGS. 8 to 11 are timing diagrams illustrating aspects of a third sub-gate signal supplied in a display scan period and a self-scan period.

FIG. 12 is a block diagram illustrating an electronic device according to embodiments.

FIG. 13 is a diagram illustrating an example in which the electronic device of FIG. 12 is implemented as a smartphone.

### DETAILED DESCRIPTION

Hereinafter, aspects of some embodiments of the present disclosure are described in more detail with reference to the accompanying drawings. It should be noted that in the following description, only portions necessary for understanding an operation according to the disclosure are described, and descriptions of other portions are omitted in order not to obscure the subject matter of the disclosure. The disclosure may be embodied in other forms without being limited to the embodiments described herein. However, the embodiments described herein are provided to describe in detail enough to implement the technical spirit of embodiments according to the present disclosure to those skilled in the art to which the disclosure belongs.

Throughout the specification, in a case where a portion is “connected” to another portion, the case includes not only a case where the portion is “directly connected” but also a case where the portion is “indirectly connected” with another element interposed therebetween. Terms used herein are for describing specific embodiments and are not intended to limit the disclosure. Throughout the specification, in a case where a certain portion “includes”, the case means that the portion may further include another component without excluding another component unless otherwise stated. “At least any one of X, Y, and Z” and “at least any one selected from a group consisting of X, Y, and Z” may be interpreted as one X, one Y, one Z, or any combination of two or more of X, Y, and Z (for example, XYZ, XYY, YZ, and ZZ). Here, “and/or” includes all combinations of one or more of corresponding configurations.

Here, terms such as first and second may be used to describe various components, but these components are not limited to these terms. These terms are used to distinguish one component from another component. Therefore, a first component may refer to a second component within a range without departing from the scope disclosed herein.

Spatially relative terms such as “under”, “on”, and the like may be used for descriptive purposes, thereby describing a relationship between one element or feature and another element(s) or feature(s) as shown in the drawings. Spatially relative terms are intended to include other directions in use, in operation, and/or in manufacturing, in addition to the direction depicted in the drawings. For example, in case that a device shown in the drawing is turned upside down, elements depicted as being positioned “under” other elements or features are positioned in a direction “on” the other elements or features. Therefore, in the present disclosure, the term “under” may include both directions of on and under. The device may face in other directions (for example, rotated 90 degrees or in other directions) and thus the spatially relative terms used herein are interpreted according thereto.

Various embodiments are described with reference to drawings schematically illustrating ideal embodiments. Accordingly, it will be expected that shapes may vary, for example, according to tolerances and/or manufacturing techniques. Therefore, the embodiments disclosed herein cannot be construed as being limited to shown specific shapes, and should be interpreted as including, for example, changes in shapes that occur as a result of manufacturing. As such, the shapes shown in the drawings may not show actual shapes of areas of a device, and embodiments according to the present disclosure are not limited thereto.

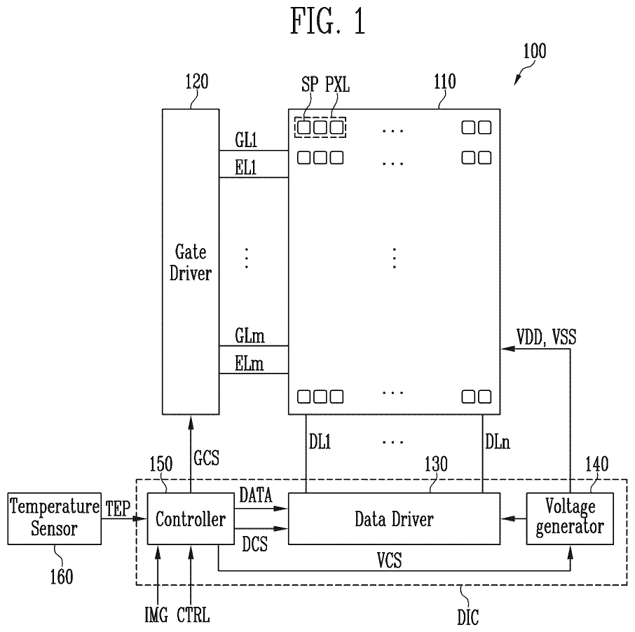

FIG. 1 is a block diagram illustrating aspects of a display device according to some embodiments.

Referring to FIG. 1, a display device 100 may include a display panel 110, a gate driver 120, a data driver 130, a voltage generator 140, and a controller 150.

The display panel 110 includes sub-pixels SP. The sub-pixels SP may be connected to the gate driver 120 through the first to m-th gate lines GL1 to GLm. The sub-pixels SP may be connected to the data driver 130 through the first to n-th data lines DL1 to DLn.

Each of the sub-pixels SP may include at least one light-emitting element configured to generate light. Accordingly, each of the sub-pixels SP may generate light of a specific color such as red, green, blue, cyan, magenta, yellow, the like. Two or more sub-pixels among the sub-pixels SP may form a pixel PXL. For example, as shown in FIG. 1, three sub-pixels may form a pixel PXL.

The gate driver 120 is connected to the sub-pixels SP arranged in the row direction through the first to m-th gate lines GL1 to GLm. The gate driver 120 may output gate signals to the first to m-th gate lines GL1 to GLm in response to the gate control signal GCS. According to some embodiments, the gate control signal GCS may include a start signal indicating the start of each frame, a horizontal synchronization signal for outputting gate signals in synchronization with the timing at which the data signals are applied, and the like.

According to some embodiments, the first to m-th light emission control lines EL1 to ELm connected to the sub-pixels SP in the row direction may be further provided. In this case, the gate driver 120 may include a light emission control driver configured to control the first to m-th light emission control lines EL1 to ELm, and the light emission control driver may operate under the control of the controller 150.

The gate driver 120 may be located on a side of the display panel 110. However, embodiments according to the present disclosure are not limited thereto. For example, the gate driver 120 may be divided into two or more drivers that are physically and/or logically divided, and such drivers may be located on a first side of the display panel 110 and a second side of the display screen 110 opposite to the first side. As such, the gate driver 120 may be arranged around the display panel 110 in various forms according to embodiments.

The data driver 130 is connected to the sub-pixels SP arranged in the column direction through the first to n-th data lines DL1 to DLn. The data driver 130 receives the image data DATA and the data control signal DCS from the controller 150. The data driver 130 operates in response to a data control signal DCS. According to some embodiments, the data control signal DCS may include a source start pulse, a source shift clock, a source output enable signal, and the like.

The data driver 130 may apply data signals having grayscale voltages corresponding to the image data DATA to the first to nth data lines DL1 to DLn using voltages from the voltage generator 140. When a gate signal is applied to each of the first to m-th gate lines GL1 to GLm, data signals corresponding to the image data DATA may be applied to the data lines DL1 to DLm. Accordingly, the corresponding sub-pixels SP may generate light corresponding to the data signals. Accordingly, an image is displayed on the display panel 110.

According to some embodiments, the gate driver 120 and the data driver 130 may include complementary metal-oxide semiconductor (CMOS) circuit elements.

The voltage generator 140 may operate in response to the voltage control signal VCS from the controller 150. The voltage generator 140 is configured to generate a plurality of voltages and provide the generated voltages to the components of the display device 100. For example, the voltage generator 140 may be configured to generate a plurality of voltages by receiving an input voltage from a device external to the display device 100, adjusting the received voltage, and regulating the adjusted voltage.

The voltage generator 140 may generate a first power supply voltage VDD and a second power supply voltage VSS, and may provide the first and second power supply voltages VDD and VSS to the sub-pixels SP. The first power supply voltage VDD may have a relatively high voltage level, and the second power supply voltage VSS may have a lower voltage level than the first power supply voltageVDD. In other embodiments, the first power supply voltage VDD or the second power supply voltage VSS may be provided by an external device of the display device 100.

In addition, the voltage generator 140 may generate various voltages. For example, the voltage generator 140 may generate an initialization voltage applied to the sub-pixels SP. For example, during a sensing operation for sensing electrical characteristics of transistors and/or light-emitting elements of the sub-pixels SP, a reference voltage may be applied to the first to n-th data lines DL1 to DLn, and the voltage generator 140 may generate such a reference voltage.

The controller 150 controls various operations of the display device 100. The controller 150 receives the input image data IMG and the control signal CTRL for controlling the display thereof from the outside. The controller 150 may provide the gate control signal GCS, the data control signal DCS, and the voltage control signal VCS in response to the control signal CTRL.

The controller 150 may output the image data DATA by converting the input image data IMG to be suitable for the display device 100 or the display panel 110. According to some embodiments, the controller 150 may arrange the input image data IMG to be suitable for the sub-pixels SP of in units of rows and output the arranged image data IMG.

Two or more components of the data driver 130, the voltage generator 140, and the controller 150 may be mounted in one integrated circuit. As shown in FIG. 1, the data driver 130, the voltage generator 140, and the controller 150 may be included in a driver integrated circuit (DIC). In this case, the data driver 130, the voltage generator 140, and the controller 150 may be components functionally separated from each other within one driver integrated circuit (DIC). In other embodiments, at least one of the data driver 130, the voltage generator 140, and the controller 150 may be provided as a component separate from the driver integrated circuit DIC.

The display device 100 may include at least one temperature sensor 160. The temperature sensor 160 is configured to sense the temperature around it and generate temperature data (TEP) indicative of the sensed temperature. According to some embodiments, the temperature sensor 160 may be located adjacent to the display panel 110 and/or the driver integrated circuit DIC.

The controller 150 may control various operations of the display device 100 in response to the temperature data TEP. According to some embodiments, the controller 150 may adjust the luminance of the image output from the display panel 110 in response to the temperature data TEP. For example, the controller 150 may adjust the data signals and the first and second power supply voltages VDD and VSS by controlling components such as the data driver 130 and/or the voltage generator 140.

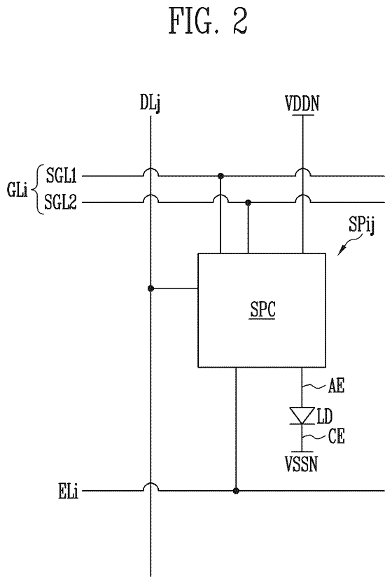

FIG. 2 is a block diagram illustrating further details of any one of the sub-pixels of FIG. 1 according to some embodiments. In FIG. 2, among the sub-pixels SP in FIG. 1, a sub-pixel SPij arranged in the i-th row (i is an integer greater than or equal to 1 and less than or equal to m) and the j-th column (j is an integer larger than or equal to 1, and less than or equivalent to n) is shown as an example.

Referring to FIG. 2, the sub-pixel SPij may include a sub-pixel circuit SPC and a light-emitting element LD.

The light emitting device LD is connected between a first power supply voltage node VDDN and a second power supply voltage node VSSN. In this case, the first power supply voltage node VDDN is a node that transmits the first power supply volt VDD of FIG. 1, and the second power supply voltage node VSSN is a node that transmits the second power supply volts VSS of FIG. 1.

An anode electrode AE of the light-emitting element LD may be connected to the first power supply voltage node VDDN through the sub-pixel circuit SPC, and a cathode electrode CE of the light-emitting element LD may be coupled to the second power supply voltage node VSSN. For example, the anode electrode AE of the light emitting device LD may be connected to the first power supply voltage node VDDN through one or more transistors included in the sub-pixel circuit SPC.

The sub-pixel circuit SPC may be connected to the i-th gate line GLi among the first to m-th gate lines GL1 to GLm of FIG. 1, the i-th light emission control line ELi among the first to n-th light emission control lines EL1 to ELm of FIG. 1, and the j-th data line DLj among the first to n-th data lines DL1 to DLn of FIG. 1. The sub-pixel circuit SPC is configured to control the light emitting device LD according to signals received through these signal lines.

The sub-pixel circuit SPC may operate in response to a gate signal received through the i-th gate line GLi. The i-th gate line GLi may include one or more sub-gate lines. According to some embodiments, as shown in FIG. 2, the i-th gate line GLi may include first and second sub-gate lines SGL1 and SGL2. The sub-pixel circuit SPC may operate in response to gate signals received through the first and second sub-gate lines SGL1 and SGL2. As such, when the i-th gate line GLi includes two or more sub-gate lines, the sub-pixel circuit SPC may operate in response to gate signals received through the corresponding sub-gate lines.

The sub-pixel circuit SPC may operate in response to a light emission control signal received through the i-th light emission control line ELi. According to some embodiments, the i-th light emission control line ELi may include one or more sub-emission control lines. In case where the i-th light emission control line ELi includes two or more sub-light emission control lines, the sub-pixel circuit SPC may operate in response to light emission control signals received through the corresponding sub-light emission control line.

The sub-pixel circuit SPC may receive a data signal through the j-th data line DLj. The sub-pixel circuit SPC may store a voltage corresponding to the data signal in response to at least one of the gate signals received through the first and second sub-gate lines SGL1 and SGL2. In response to the light emission control signal received through the i-th light emission control line ELi, the sub-pixel circuit SPC may adjust the current flowing from the first power supply voltage node VDDN to the second power supply voltage node VSSN through the light emitting element LD according to the stored voltage. Accordingly, the light-emitting element LD may generate light having a luminance corresponding to the data signal.

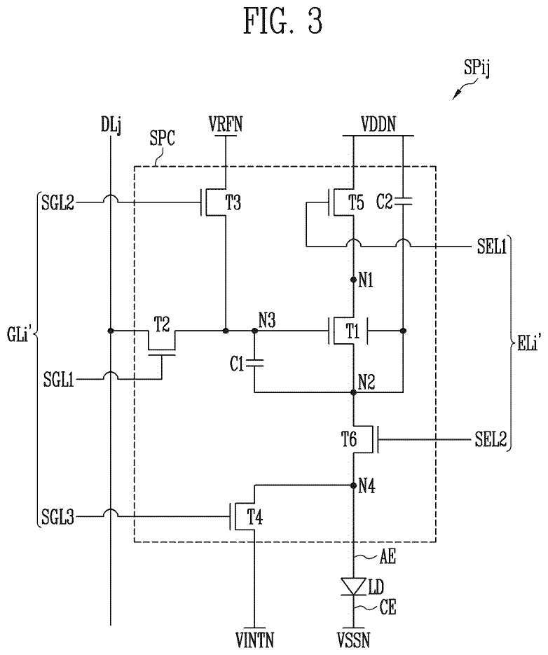

FIG. 3 is a circuit diagram illustrating further details of the sub-pixel in FIG. 2 according to some embodiments. Although FIG. 3 illustrates various components in a sub-pixel according to some embodiments, embodiments according to the present disclosure are not limited thereto, and according to various embodiments, the sub-pixel may include additional components or fewer components without departing from the spirit and scope of embodiments according to the present disclosure.

Referring to FIG. 3, the sub-pixel SPij may include a sub-pixel circuit SPC and a light-emitting element LD.

The sub-pixel circuit SPC may be connected to the i-th gate line GLi′, the i-th light emission control line ELi′, and the j-th data line DLj. Compared to the i-th gate line GLi in FIG. 2, the i-th gate line GLi′ may further include a third sub-gate line SGL3. Compared to the i-th emission control line ELi in FIG. 2, the i-th light emission control line ELi′ may include a first sub-light emission control line SEL1 and a second sub-light emission control line SEL2.

The sub-pixel circuit SPC may include first to sixth transistors T1 to T6, a first capacitor C1, and a second capacitor C2.

The first transistor T1 is connected between a first node N1 and a second node N2. The first node N1 receives a first power supply voltage. A gate electrode of the first transistor T1 is connected to a third node N3, and accordingly, the first transistor T2 may be turned on according to a voltage level of the third node N3. The first transistor T1 may be referred to as a driving transistor.

The second transistor T2 is connected between the j-th data line DLj and the third node N3. A gate electrode of the second transistor T2 is connected to the first sub-gate line SGL1, and accordingly, the second transistor T1 may be turned on in response to a sub-gate signal of the first sub-gate line SGL1. When the second transistor T2 is turned on, the data voltage may be provided to the third node N3. The second transistor T2 may be referred to as a switching transistor.

The third transistor T3 is connected between the reference voltage node VRFN and the third node N3. The reference voltage node VRFN is configured to transmit a reference voltage. According to some embodiments, the reference voltage may be provided by the voltage generator 140 of FIG. 1. The reference voltage may have a value between the first power supply voltage and the second power supply voltage.

A gate electrode of the third transistor T3 is connected to the second sub-gate line SGL2, and accordingly, the third transistor T2 may be turned on in response to a sub-gate signal of the second sub-gate line SGL2. When the third transistor T3 is turned on, the reference voltage may be provided to the third node N3.

The fourth transistor T4 is connected between a fourth node N4 and the initialization voltage node VINTN. The initialization voltage node VINTN is configured to transmit the initialization voltage. According to some embodiments, the initialization voltage may be provided by the voltage generator 140 of FIG. 1. The initialization voltage may have a value between the first power supply voltage and the second power supply voltage.

A gate electrode of the fourth transistor T4 is connected to the third sub-gate line SGL3, and accordingly, the fourth transistor T4 may be turned on in response to a sub-gate signal of the third sub-gate line SGL3.

The fifth transistor T5 is connected between the first power supply voltage node VDDN and the first node N1. A gate electrode of the fifth transistor T5 is connected to a first sub-light emission control line SEL1, and accordingly, the fifth transistor T5 may be turned on in response to a first sub-light emission control signal of the first sub-light emission control line SEL1. The first node N1 may receive the first power supply voltage through the fifth transistor T5.

The sixth transistor T6 is connected between the second node N2 and the fourth node N4 (i.e., the anode electrode of the light emitting device LD). A gate electrode of the sixth transistor T6 is connected to a second sub-light emission control line SEL2, and accordingly, the sixth transistor T6 may be turned on in response to a second sub-light emission control signal of the second sub-light emission control line SEL2.

The first capacitor C1 may be connected between the second node N2 and the third node N3. A voltage corresponding to the data signal may be stored in the first capacitor C1.

The second capacitor C2 may be connected between the first power supply voltage VDDN and the second node N2. The second capacitor C2 may stabilize the voltage of the second node N2.

As such, the sub-pixel circuit SPC may include first to sixth transistors T1 to T6, and a first capacitor C1 and a second capacitor C2. However, embodiments according to the present disclosure are not limited thereto.

A sub-pixel circuit SPC may be implemented as any one of various types of circuits including a plurality of transistors and one or more capacitors. For example, a sub-pixel circuit SPC may include two transistors and one capacitor. According to embodiments of the sub-pixel circuit SPC, the number of sub-gate lines included in the i-th gate line GLi′ and the number of sub-light emission control lines included in the e-th light emission control line ELi′ may vary.

Each of the first to sixth transistors T1 to T6 may be a metal oxide silicon field effect transistor (MOSFET).

Each of the first to sixth transistors T1 to T6 may be an N-type transistor. In this case, a turn-on level may be a high voltage level, and a turn-off level may be a low voltage level. When a signal applied to a gate electrode of an N-type transistor has a low voltage level, the N-type transistor may be turned off. For example, when a signal applied to a gate electrode of an N-type transistor has a high voltage level, the N-type transistor may be turned on.

However, embodiments according to the present disclosure are not limited thereto. For example, some of the first to sixth transistors T1 to T6 may be implemented as P-type transistors. In this case, a turn-on level may be a low voltage level and a turn-off level may be a high voltage level. For example, when a signal applied to a gate electrode of a P-type transistor has a low voltage level, the P-type transistor may be turned on. For example, when a signal applied to a gate electrode of a P-type transistor has a high voltage level, the P-type transistor may be turned off.

Hereinafter, the meaning of “a sub-gate signal is supplied” may be understood as the sub-gate signal being supplied at a logic level that turns on the transistor controlled thereby. In addition, the meaning of “supply of the sub-gate signal is interrupted” may be understood as the sub-gate signals being supplied at a logic level that turns off the transistors controlled thereby.

In addition, the meaning of “light-emitting control signal is supplied” may be understood as the light-emitting control signal being supplied at a logic level that turns on the transistor controlled thereby. In addition, the meaning of “supply of the light-emitting control signal is interrupted” may be understood to mean that the light-emitting control signal is supplied at a logic level that turns off the transistor controlled thereby.

The light emitting device LD may include an anode electrode AE, a cathode electrode CE, and a light emitting layer. The light emitting layer may be located between the anode electrode AE and the cathode electrode CE. After the data signal transmitted through the j-th data line DLj is reflected in the voltage of the third node N3, the fifth and sixth transistors T5 and T6 may be turned on when the first light-emitting control signal applied to the first sub-light emission control line SEL1 and the second light-emitting control signals applied to the second sub-light emission control line SEL2 are enabled to a high voltage level.

In addition, the first transistor T1 may be turned on according to the voltage of the third node N3, and accordingly, current may flow from the first power supply voltage node VDDN to the second power supply voltage node VSSN. A light-emitting device LD may emit light according to the amount of current flowing therethrough.

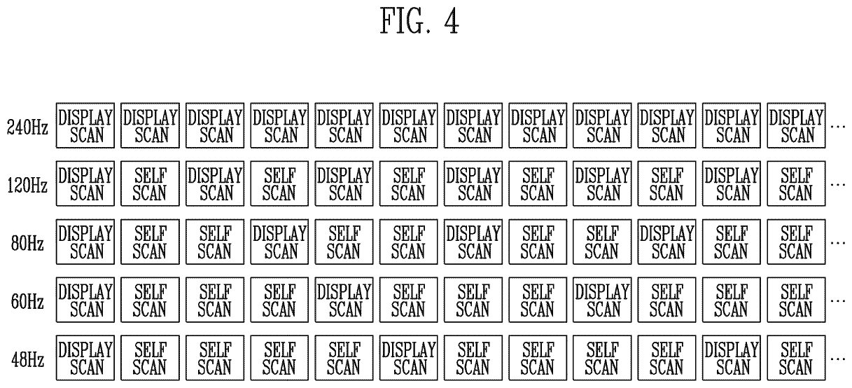

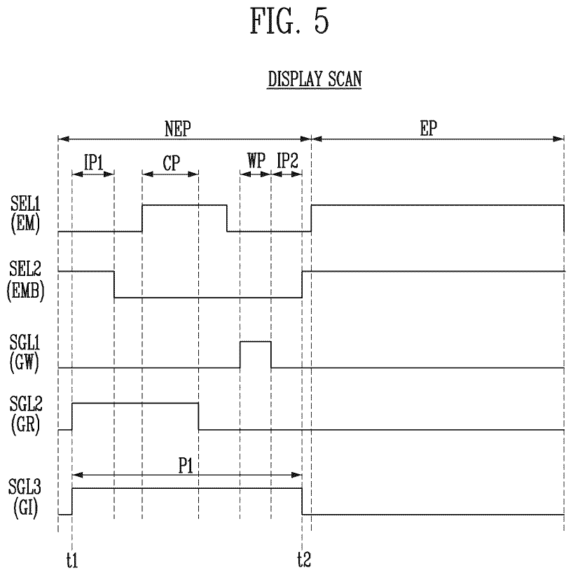

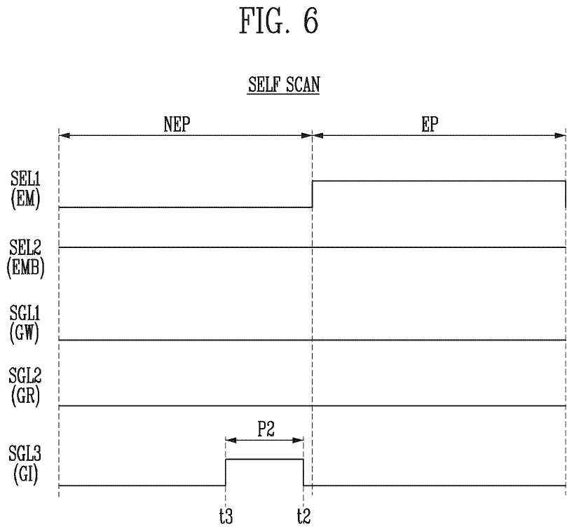

FIG. 4 is a conceptual diagram illustrating a driving operation of the display device of FIG. 1. FIG. 5 is a timing diagram illustrating an example in which the display device of FIG. 1 performs a display scan operation. FIG. 6 is a timing diagram illustrating an example in which the display device of FIG. 1 performs a self-scan operation.

Referring to FIGS. 1 and 4, one frame may include a display scan period (DISPLAY SCAN) or a self-scan period (SELF SCAN).

During the display scan period (DISPLAY SCAN), a display scan operation in which a data voltage VDATA is written may be performed. During the (SELF SCAN), a self-scan operation in which the light-emitting element emits light without writing the data voltage VDATA may be performed.

The display scan period (DISPLAY SCAN) may be continuously repeated for a frame at the maximum driving frequency of the display panel 110 (for example, when the driving frequency is 240 Hz).

The display scan period (DISPLAY SCAN) may be included in a frame and the self-scan period (SELF SCAN) may be included in at least one frame at driving frequencies (e.g, 120 Hz, 80 Hz, 60 Hz, and 48 Hz) excluding the maximum driving frequency of the display panel 110. In FIG. 4, the maximum driving frequency is assumed to be 240 Hz.

For example, when the driving frequency is 120 Hz, the display scan period (DISPLAY SCAN) of one frame and the self-scan period (SELF SCAN) of the one frame may be repeated. The display scan period (DISPLAY SCAN) of one frame and the self-scan period (SELF SCAN) of one frame may form one driving frame. The same image may be displayed during one driving frame.

When the driving frequency is 80 Hz, the display scan period (DISPLAY SCAN) of one frame and the self-scan period (SELF SCAN) of two frames may be repeated. The display scan period (DISPLAY SCAN) of one frame and the self-scan period (SELF SCAN) of two frames may form one driving frame.

When the driving frequency is 60 Hz, the display scan period (DISPLAY SCAN) of one frame and the self-scan period (SELF SCAN) of three frames may be repeated. The display scan period (DISPLAY SCAN) of one frame and the self-scan period (SELF SCAN) of three frames may form one driving frame.

When the driving frequency is 48 Hz, the display scan period (DISPLAY SCAN) of one frame and the self-scan period (SELF SCAN) of four frames may be repeated. The display scan period (DISPLAY SCAN) of one frame and the self-scan period (SELF SCAN) of four frames may form one driving frame.

As such, the driving control unit 200 may change the driving frequency by adjusting the length of the self-scan section (SELF SCAN).

Referring to FIG. 5, the frame including the display scan period (DISPLAY SCAN) may include a non-emission period NEP and an emission period EP.

The non-emission period NEP may include a first initialization period IP1, a compensation period CP, a data writing period WP, and a second initialization period IP2.

The first initialization period IP1 may be a period for initializing the first capacitor C1. The compensation period CP may be a period for compensating the threshold voltage of the first transistor T1. The data writing period WP may be a period in which the voltage of the data signal is stored in the sub-pixel SPij. The second initialization period IP2 may be a period for initializing the light emitting device LD.

During the first initialization period IP1, a second sub-gate signal GR may be supplied to the second sub-gate line SGL2, a third sub-gate signal GI may be supplied to a third sub-gate line SGL3, and a second sub-light emission control signal EMB may be supplied to second sub-light emission control line SEL2. A first sub-gate signal GW may not be supplied to the first sub-gate line SGL1, and a first sub-light emission control signal EM may not be supplied to the first sub-light emission control line SEL1.

When the first sub-light emission control signal EM is not supplied to the first sub-light emission control line SEL1, the fifth transistor T5 may be turned off. When the fifth transistor T5 is turned off, electrical connection between the first power supply voltage node VDDN and the first transistor T1 is disconnected, and accordingly, the light emitting device LD may be set to a non-light emitting state.

When the second sub-gate signal GR is supplied to the second sub-gate line SGL2, the third transistor T3 is turned on. When the third transistor T3 is turned on, the reference voltage is supplied to the third node N3.

When the third sub-gate signal GI is supplied to the third sub-gate line SGL3, the fourth transistor T4 is turned on. When the fourth transistor T4 is turned on, the initialization voltage may be supplied to the fourth node N4. That is, the third sub-gate signal GI may control a time (or a time point) at which the fourth node N4 is initialized.

When the second sub-light emission control signal EMB is supplied to the second sub-light emission control line SEL2, the sixth transistor T6 is turned on. When the sixth transistor T6 is turned on, the initialization voltage of the fourth node N4 may be supplied to the second node N2.

When the reference voltage is supplied to the third node N3 and the initialization voltage is supplied to the second node N2, the first capacitor C1 and the second capacitor C2 may be initialized. That is, the first initialization period IP1 may be a period for initializing the sub-pixel SPij so as not to be affected by the data signal supplied in the previous frame period.

During the compensation period CP, the second sub-gate signal GR may be supplied to the second sub-gate line SGL2, and the third sub-gate signal GI may be supplied to a third sub-gate line SGL3. The supply of the second sub-light emission control signal EMB to the second sub-light emission control line SEL2 may be interrupted, and the first sub-light emission control signal EM may be supplied to the first sub-light emission controlling line SEL1.

When the supply of the second sub-light emission control signal EMB to the second sub-light emission control line SEL2 is interrupted, the sixth transistor T6 may be turned off. When the sixth transistor T6 is turned off, electrical connection between the second power supply voltage node VSSN and the first transistor T1 is disconnected, and accordingly, the light emitting device LD may be set to a non-light emitting state.

When the first sub-light emission control signal EM is supplied to the first sub-light emission control line SEL1, the fifth transistor T5 may be turned on. When the fifth transistor T5 is turned on, the first power supply voltage may be supplied to the first node N1.

When the second sub-gate signal GR is supplied to the second sub-gate line SGL2, the third transistor T3 is turned on. When the third transistor T3 is turned on, the reference voltage is supplied to the third node N3.

Here, the reference voltage is set so that the first transistor T1 may be turned on, and accordingly, the voltage of the second node N2 may be increased in response to the current supplied from the first transistor T2. The voltage of the second node N2 may be increased to a value obtained by subtracting the absolute threshold voltage of the first transistor T1 from the reference voltage. As such, during the compensation period CP, a voltage corresponding to the threshold voltage of the first transistor T1 may be stored in the first capacitor C1.

When the third sub-gate signal GI is supplied to the third sub-gate line SGL3, the fourth transistor T4 is turned on. When the fourth transistor T4 is turned on, the initialization voltage may be supplied to the fourth node N4.

During the data writing period WP, a first sub-gate signal GW may be supplied to the first sub-gate line SGL1 and a third sub-gate signal GI may be supplied to a third sub-gate line SGL3. In addition, the supply of the second sub-gate signal GR to the second sub-gate line SGL2 may be interrupted, and the supply of the first sub-light emission control signal EM to the first sub-light emission control line SEL1 may be interrupted.

When the supply of the first sub-emission control signal EM and the second sub-light emission control signal EMB is interrupted, the fifth and sixth transistors T5 and T6 may be turned off. Accordingly, electrical connection between the first power voltage node VDDN and the second power voltage node VSSN and the first transistor T1 is disconnected, and accordingly, the light-emitting element LD may be set to a non-light emitting state.

When the first sub-gate signal GW is supplied to the first sub-gate line SGL1, the second transistor T2 is turned on. When the second transistor T2 is turned on, the data voltage from the data line DLj may be supplied to the third node N3.

Accordingly, a data voltage may be written to the first capacitor C1. In this case, the data voltage written to the first capacitor C1 is a voltage reflecting a decrease in the threshold voltage of the first transistor T1.

During the second initialization period IP2, the supply of the first sub-gate signal GW to the first sub-gate line SGL1 may be stopped, and the supply of the third sub-gate signal GI to the third sub-gate line SGL3 may be maintained.

When the third sub-gate signal GI is supplied to the third sub-gate line SGL3, the fourth transistor T4 is turned on. When the fourth transistor T4 is turned on, the initialization voltage may be supplied to the fourth node N4. When the initialization voltage is supplied to the fourth node N4, the anode electrode AE of the light-emitting element LD (or the parasitic capacitor of the light-emitting element LD) may be initialized to the initialization voltage.

During the emission period EP, the first sub-light emission control signal EM may be supplied to the first sub-light emission control line SEL1, and the second sub-light emission control signal EMB may be supplied to a second sub-light emission control line SEL2.

When the first sub-light emission control signal EM is supplied, the fifth transistor T5 may be turned on. Accordingly, the first power supply voltage node VDDN and the first transistor T1 may be electrically connected.

In this case, the first transistor T1 may supply the driving current corresponding to the voltage of the third node N3 from the first power supply voltage node VDDN to the second power supply voltage node VSSN via the light-emitting element LD. Then, during the emission period EP, the light-emitting element LD may generate light of a luminance corresponding to the driving current.

Referring to FIG. 5, the third sub-gate signal GI may be supplied to the third sub-gate line SGL3 during a first period P1 between a first time t1 and a second time t2.

Referring to FIG. 6, a frame including a self-scan period (SELF SCAN) may include a non-emission period NEP and an emission period EP.

The non-emission period NEP may include a second period P2 in which the third sub-gate signal GI is supplied to the third sub-gate line SGL3.

During the non-emission period NEP, the second sub-light emission control signal EMB may be supplied to the second sub-light emission control line SEL2. When the second sub-light emission control signal EMB is supplied to the second sub-light emission control line SEL2, the second node N2 and the fourth node N4 may be connected as the sixth transistor T6 is turned on.

During the non-emission period NEP, the first sub-light emission control signal EM may not be supplied to the first sub-light emission control line SEL1, the first sub-gate signal GW may not be supplied to the first sub-gate line SGL1, and the second sub-gate signal GR may not be provided to the second sub-gate line SGL2.

When the first sub-light emission control signal EM is not supplied to the first sub-light emission control line SEL1, the fifth transistor T5 may be turned off. When the fifth transistor T5 is turned off, electrical connection between the first power supply voltage node VDDN and the first transistor T1 is disconnected, and accordingly, the light emitting device LD may be set to a non-light emitting state.

During a second period PL2 between the third time t3 and the second time t2, the third sub-gate signal GI may be supplied to the third sub-gate line SGL3. When the third sub-gate signal GI is supplied to the third sub-gate line SGL3, the fourth transistor T4 is turned on, and accordingly, the anode electrode AE of the light-emitting element LD may be initialized to the initialization voltage.

During the emission period EP, the first sub-light emission control signal EM may be supplied to the first sub-light emission control line SEL1, and the second sub-light emission control signal EMB may be supplied to a second sub-light emission control line SEL2.

When the first sub-light emission control signal EM is supplied, the fifth transistor T5 may be turned on. Accordingly, the first power supply voltage node VDDN and the first transistor T1 may be electrically connected.

In this case, the first transistor T1 may supply the driving current corresponding to the voltage of the third node N3 from the first power supply voltage node VDDN to the second power supply voltage node VSSN via the light-emitting element LD. Accordingly, during the emission period EP, the light-emitting element LD may generate light of a luminance corresponding to the driving current.

During the self-scan period (SELF SCAN), the sub-gate signals GW and GR controlling the second and third transistors T2 and T3 that affect the voltage level of the gate electrode of the first transistor T1 remain in an inactive state of a low-level. In other words, the supply of the first sub-gate signal GW and the second sub-gate signal GR is interrupted during the self-scan period (SELF SCAN).

In addition, the third sub-gate signal GI that controls the fourth transistor T4 may be activated to initialize the anode electrode AE of the light emitting device LD during the self-scanning period (SELF SCAN).

In this way, only the third sub-gate signal GI among the first to third sub-gate signals GW, GR, and GI may be supplied to initialize the anode electrode AE of the light-emitting element LD during the self-scanning period (SELF SCAN).

Accordingly, the data voltage written to the first capacitor C1 may not be changed during the self-scan period (SELF SCAN). Therefore, the sub-pixel SPij may display the same image during the display scan period DISPLAY SCAN and the self-scan period (SELF SCAN) based on the data voltage supplied during the data writing period WP.

Referring to FIG. 6, the third sub-gate signal GI may be supplied to the third sub-gate line SGL3 during a second period P2 between the third time t3 and the second time t2.

The third sub-gate signal GI may be supplied for the second period P2 during the self-scan period (SELF SCAN), and the third sub-gate signal GI may be provided for the first period P1 during the display scan period (DISPLAY SCAN) of FIG. 5.

The length of the period in which the third sub-gate signal GI is supplied during the self-scan period (SELF SCAN) may be different from the length of the period in which the third sub-gate signal GI is supplied during the display scan period (DISPLAY SCAN).

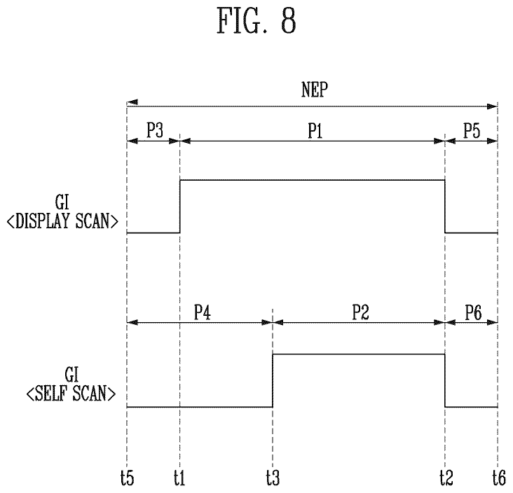

For example, the length of the second period P2 during which the third sub-gate signal GI is supplied during the self-scan period (SELF SCAN) may be shorter than the length of the first period P1 during which the third sub-gate signal GI is supplied in the display scan period (DISPLAY SCAN). Further details according to some embodiments are illustrated and described below in conjunction with FIGS. 8 to 11.

The period during which the third sub-gate signal GI is supplied during the self-scan period (SELF SCAN) is different from the period during which the third sub-gate signal GI is supplied during the display scan period (DISPLAY SCAN), so that it may prevent or reduce instances of a pattern displayed in some areas of the display panel 110 being copied and expressed as mura in other areas.

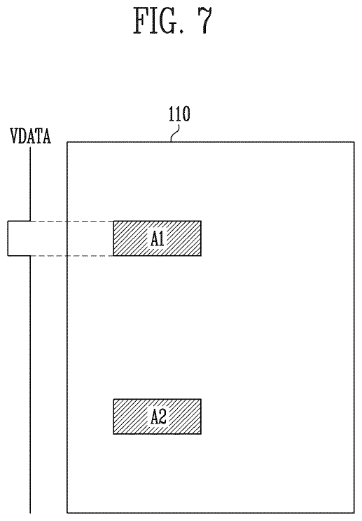

FIG. 7 is a diagram for illustrating a phenomenon in which a pattern displayed in a partial area of a display panel is copied and expressed in another area.

Referring to FIG. 7, a first area A1 in which a pattern is displayed and a second area A2 in which mura is generated due to the pattern of the first area A1 are shown.

Hereinafter, FIG. 7 will be described in a case where the display device 100 drives the display panel in two cycles and displays a pattern in the first area A1. The displayed pattern may have a large difference in grayscale value (or luminance value) from an adjacent area. Here, the two-cycle driving means that two areas of the display panel display different subframes. However, embodiments according to the present disclosure are not limited thereto, and the display device 100 may drive the display panel for two or more cycles.

The difference between the grayscale value of the first area A1 and the grayscale value of an area different from the first area A1, may be greater than a reference grayscale value. The reference grayscale value may have a preset value. For example, difference between a grayscale value of the first area A1 and a grayscale value of the area adjacent to the first area A1 may be greater than the reference grayscale value.

For example, as shown in FIG. 3, in case where the first transistor T1 is an N-type transistor, as the grayscale value decreases, the data voltage VDATA corresponding to the grayscale value may decrease.

For descriptive convenience, as shown in FIG. 7, it is assumed that the grayscale value of the first area A1 is lower than the grayscale value of an area different from the first area A1. In this case, the data voltage VDATA may increase at the end portion of the first area A1. As the data voltage VDATA increases, a voltage of the anode electrode AE of the light-emitting element LD may increase due to coupling caused by a parasitic capacitor between the anode electrode AE and the data line DLj. For example, some of sub-pixels of the second area A2 are connected to the data line DLj along with sub-pixels of the first area A1, and the voltage of the anode electrode AE of the light-emitting element LD of the sup-pixel in the second area A2 may increase as the data voltage VDATA increases. As the voltage of the anode electrode AE of the light-emitting element LD increases, the voltage difference between the anode electrode AE of the light-emitting element LD and the cathode electrode CE of the light-emitting element LD increases, which may cause the sub-pixels of the second area A2 to emit unintended light. As such, an unintended image or characteristic, such as mura, may be displayed in the second region A2 due to the displayed pattern of the first region A1.

Due to the voltage coupling between the anode electrode AE and the data line DLj as described above, the first region A1 may cause changes in a grayscale of the second region A2 in various aspects. The self-scan operation (see FIG. 6) may be performed for subpixels SP of a row corresponding to the first region A1 (hereinafter referred to as a subpixel row) when the display scan operation (see FIG. 5) is performed for a subpixel row corresponding to the second region A2. In other words, the display scan operation for the subpixel row corresponding to the second region A2 may temporally overlap the self-scan operation for the subpixel row corresponding to the first region A1. In such a case, the third sub-gate signal GI is supplied to the subpixel row corresponding to the first region A1, and the initialization voltage of the initialization voltage node VINTN may be supplied to the anode electrode AE of the corresponding subpixels. Similarly, the third sub-gate signal GI is also supplied to the subpixel row corresponding to the second region A2, and the initialization voltage of the initialization voltage node VINTN may be supplied to the anode electrode AE of the corresponding subpixels.

The voltage change of the anode electrode AE may cause a change in the data voltage VDATA of the data line DLj due to the voltage coupling between the anode electrode AE and the data line DLj. Upon supplying the third sub-gate signal GI, the voltage of the anode electrode AE of the subpixel corresponding to the first region A1 may change from the voltage corresponding to a grayscale emitted during the immediately preceding display scan operation to the initialization voltage of the initialization voltage node VINTN. The voltage change of the anode electrode AE of the subpixel in the first region A1 may cause an unintended change in the data voltage VDATA due to the voltage coupling between the anode electrode AE and the data line DLj. The changed data voltage VDATA may be supplied to the subpixel in the second region A2 on which the display scan operation is performed, potentially causing the corresponding subpixel in the second region A2 to display an unintended grayscale. As such, the grayscale of the first region A1 may affect the grayscale of the second region A2, and accordingly, mura associated with the first region A1 may appear in the second region A2.

To prevent or reduce such phenomena, as described in FIG. 6, a period in which the third sub-gate signal GI is supplied during the self-scan period (SELF SCAN) may be reduced. Accordingly, the voltage change of the anode electrode AE of the subpixel in the first region A1 may be reduced, and changes in the data voltage VDATA of the data line DLj may be prevented or reduced. Accordingly, the second region A2 may display the desired image.

Also, a period in which the third sub-gate signal GI is supplied during the display scan period (DISPLAY SCAN) may also be reduced. Accordingly, the voltage change of the anode electrode AE of the subpixel in the second region A2 may be reduced, and changes in the data voltage VDATA of the data line DLj may also be reduced. Therefore, the second region A2 may display the desired image.

As such, the period during which the third sub-gate signal GI is supplied during the self-scan period (SELF SCAN) may be set to be different from the period during which the third sub-gate signal GI is supplied during the display scan period (DISPLAY SCAN). Various embodiments of the third sub-gate signal GI supplied during the display scan period (DISPLAY SCAN) and the self-scan period (SELF SCAN) will be described below.

FIGS. 8 to 11 are timing diagrams illustrating aspects of a third sub-gate signal supplied in a display scan period and a self-scan period.

Referring to FIG. 8, during a first period P1 of the display scan period (DISPLAY SCAN), the third sub-gate signal GI is supplied, and during a second period P2 of the (SELF SCAN) the third sub-gate signal GI is supplied.

A non-emission period may be a period between the fifth time t5 and the sixth time t6. The first period P1 may be a period between a first time t1 and a second time t2. The second period P2 may be a period between a third time t3 and a second time t2.

In FIG. 8, it is shown that the first period P1 and the second period P2 are included in the same non-emission period NEP for descriptive convenience, but according to some embodiments, a non-emission period NEP including the first period P1 and a non-emission period NEP including the second period P2 may be different from each other. For example, the non-emission period NEP including the first period P1 may precede the non-emission period NEP including a second period P2.

The second period P2 during which the third sub-gate signal GI is supplied during the self-scan period (SELF SCAN) may be shorter than the first period P1 during which the third sub-gate signal G1 is supplied during the display scan period (DISPLAY SCAN).

The start time t1 of the first period P1 may be earlier than the start time t3 of the second period P2. In other words, a length of a period P3 between the start time t1 of the first period P1 and the start time t5 of the non-emission period may be shorter than a length of a period P4 between the start time t3 of the second period P2 and the start time t5 of the non-emission period.

The end time t2 of the first period P1 may be the same as the end time t2 of a second period P2. That is, a length of a period P5 between the end time t2 of the first period P1 and the end time t6 of the non-emission period including the first period P1, may be equal to a length of a period P6 between the end time t2 of the second period P2 and the end time t6 of the non-emission period including the second period P2.

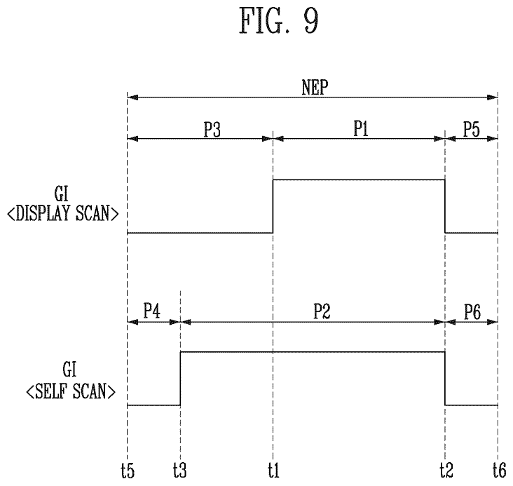

Referring to FIG. 9, the third sub-gate signal GI is supplied during a first period P1 of the display scan period (DISPLAY SCAN), and the third sub-gate signal GI is supplied during a second period P2 of the (SELF SCAN).

A non-emission period may be a period between a fifth time t5 and a sixth time t6. The first period P1 may be a period between a first time t1 and a second time t2. The second period P2 may be a period between a third time t3 and the second time t2.

In FIG. 9, it is shown that the first period P1 and the second period P2 are included in the same non-emission period NEP for the descriptive convenience, but according to some embodiments, the non-emission period NEP including the first period P1 and the non-emission period NEP including the second period P2 may be different from each other. For example, the non-emission period NEP including the first period P1 may precede the non-emission period NEP including a second period P2.

The second period P2 during which the third sub-gate signal GI is supplied during the self-scan period (SELF SCAN) may be longer than the first period P1 during which the third sub-gate signal G1 is supplied during the display scan period (DISPLAY SCAN).

The start time t1 of the first period P1 may be later than the start time t3 of the second period P2. In other words, a length of a period P3 between the start time t1 of the first period P1 and the start time t5 of the non-emission period may be longer than a length of a period P4 between the start time t3 of the second period P2 and the start time t5 of the non-emission period.

The end time t2 of the first period P1 may be the same as the end time t2 of a second period P2. That is, a length of a period P5 between the end time t2 of the first period P1 and the end time t6 of the non-emission period including the first period P1 may be equal to a length of a period P6 between the end time t2 of the second period P2 and the end time t6 of the non-emission period including the second period P2.

As described in FIGS. 8 and 9, the period during which the third sub-gate signal GI is supplied during the self-scan period (SELF SCAN) is different from the period during which the third sub-gate signal GI is supplied during the display scan period (DISPLAY SCAN), so that the phenomenon described in FIG. 7 may be prevented or reduced.

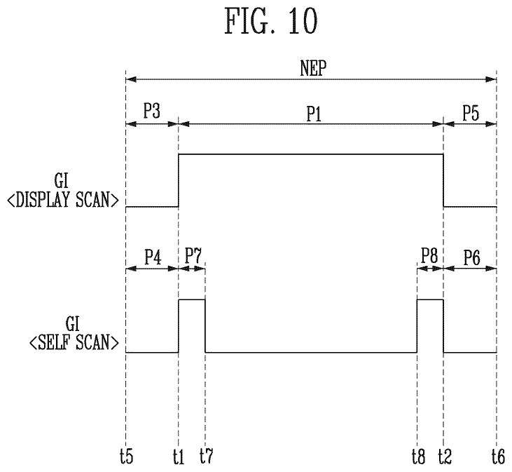

Referring to FIG. 10, the third sub-gate signal GI is supplied during a first period P1 of the display scan period (DISPLAY SCAN), and the third sub-gate signal GI is supplied during a seventh period P7 and an eighth period P8 of the self-scan period (SELF SCAN).

A non-emission period may be a period between a fifth time t5 and a sixth time t6. The first period P1 may be a period between a first time t1 and a second time t2. The seventh period P7 may be a period between the first time t1 and a seventh time t7. The eighth period P8 may be a period between an eighth time t8 and the second time t2.

In FIG. 10, it is shown that the first period P1, the seventh period P7, and the eighth period P8 are included in the same non-emission period NEP for descriptive convenience, but according to some embodiments, the non-emission period NEP including the first period P1, the non-emission period NEP including the seventh period P7, and the non-emission period NEP including the eighth period P8 may be different from each other. For example, the non-emission period NEP including the first period P1 may precede the non-emission period NEP including the seventh period P7 and the eighth period P8.

The number of times the third sub-gate signal GI is supplied during the display scan period (DISPLAY SCAN) may be different from the number of times the third sub-gate signal GI is supplied during the self-scan period (SELF SCAN).

According to some embodiments, the number of times the third sub-gate signal GI is supplied during the display scan period (DISPLAY SCAN) may be less than the number of times the third sub-gate signal GI is supplied during the self-scan period (SELF SCAN).

For example, the third sub-gate signal GI may be supplied once during the display scan period (DISPLAY SCAN), and the third sub-gate signal GI may be supplied twice during the self-scan period (SELF SCAN).

Referring to FIG. 10, the number of toggles of the third sub-gate signal GI during the display scan period (DISPLAY SCAN) may be different from the number of togles of the third sub-gate signal GI during the self-scan period (SELF SCAN). The number of toggles may refer to the number of times the logic level of the signal changes.

For example, during the display scan period (DISPLAY SCAN), the third sub-gate signal GI is toggled at the first time t1 and the second time t2, so the number of toggles is 2. On the other hand, during the self-scan period (SELF SCAN), the third sub-gate signal GI is toggled at the first time t1, the seventh time t7, the eighth time t8, and the second time t2, so the number of toggles is 4.

The start time t1 of the first period P1 may be the same as the start time t1 in the seventh period P7. In addition, the first toggle time t1 of the third sub-gate signal GI in the display scan period (DISPLAY SCAN) may be the same as the first toggle time t1 of third sub-gate signal GI in the self-scan period (SELF SCAN).

In other words, a length of a period P3 between the start time t1 of the first period P1 and the start time t5 of the non-emission period including the first period P1, may be equal to a length of a period P4 between the start time t1 of the seventh period P7 and the start time t5 of the non-emission period that includes the seventh period P7).

The end time t2 of the first period P1 may be the same as the end time t2 of the eighth period P8. In addition, the last toggle time t2 of the third sub-gate signal GI in the display scan period (DISPLAY SCAN) may be the same as the last toggle time t2 of the third sub-gate signal GI in the self-scan period (SELF SCAN).

That is, a length of a period P5 between the end time t2 of the first period P1 and the end time t6 of the non-emission period including the first period P1 may be the same as a length of a period P6 between the end time t2 of the eighth period P8 and the end time t6 of the non-emission period including the eighth period P8.

Lengths of the seventh period P7 and the eighth period P8 may be set to be adjustable in a range in which the sum of the lengths of the seventh period P7 and eighth period P8 is less than the length of the first period P1. For example, the lengths of the seventh period P7 and the eighth period P8 may be the same as or different from each other.

In addition, in FIG. 10, it is explained that the number of times the third sub-gate signal GI is supplied in the display scan period (DISPLAY SCAN) is one, and the number of times third sub-gate signal GI are supplied in the self-scan period (SELF SCAN) is two, but embodiments according to the present disclosure are not limited thereto.

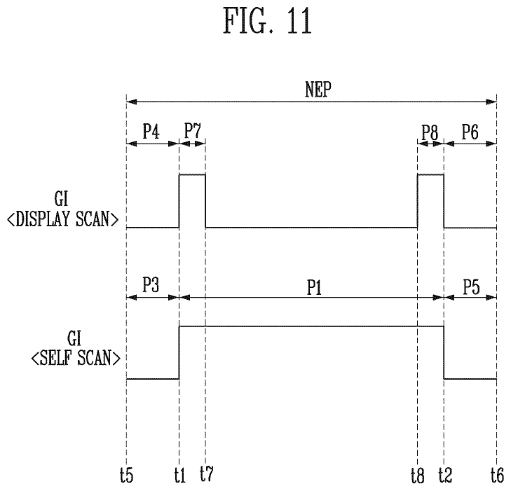

Referring to FIG. 11, the third sub-gate signal GI is supplied during a seventh period P7 and a eighth period P8 of the display scan period (DISPLAY SCAN), and the third sub-gate signal GI is supplied during a first period P1 of the self-scan period (SELF SCAN).

A non-emission period may be a period between a fifth time t5 and a sixth time t6. A first period P1 may be a period between a first time t1 and a second time t2. The seventh period P7 may be a period between the first time t1 and a seventh time t7. The eighth period P8 may be a period between a eighth time t8 and the second time t2.

In FIG. 11, it is shown that the first period P1, the seventh period P7, and the eighth period P8 are included in the same non-emission period NEP for descriptive convenience, but according to some embodiments, the non-emission period NEP including the first period P1, the non-emission period NEP of the seventh period P7, and the non-emission period NEP of the eighth period P8 may be different from each other. For example, the non-emission period NEP including the first period P1 may follow the non-emission period NEP including a seventh period P7 and an eighth period P8.

The number of times the third sub-gate signal GI is supplied during the display scan period (DISPLAY SCAN) may be different from the number of times the third sub-gate signal GI is supplied during the self-scan period (SELF SCAN).

According to some embodiments, the number of times the third sub-gate signal GI is supplied during the display scan period (DISPLAY SCAN) may be greater than the number of times the third sub-gate signal GI is supplied during the self-scan period (SELF SCAN).

For example, the third sub-gate signal GI may be supplied twice during the display scan period (DISPLAY SCAN), and the third sub-gate signal GI may be supplied once during the self-scan period (SELF SCAN).

The number of toggles of the third sub-gate signal GI during the display scan period (DISPLAY SCAN) may be different from the number of toggles of the third sub-gate signal GI during the self-scan period (SELF SCAN). The number of toggles may refer to the number of times the logic level of the signal changes.

For example, during the display scan period (DISPLAY SCAN), the third sub-gate signal GI is toggled at the first time t1, the seventh time t7, the eighth time t8, and the second time t2, so the number of toggles is four. On the other hand, during the self-scan period (SELF SCAN), the third sub-gate signal GI is toggled at the first time t1 and the second time t2, so the number of toggles is 2.

The start time t1 of the first period P1 may be the same as the start time t1 in the seventh period P7. In addition, the first toggle time t1 of the third sub-gate signal GI in the display scan period (DISPLAY SCAN) may be the same as the first toggle time t1 of third sub-gate signal GI in the self-scan period (SELF SCAN).

In other words, a length of a period P3 between the start time t1 of the first period P1 and the start time t5 of the non-emission period including the first period P1 may be equal to a length of a period P4 between the start time t1 of the seventh period P7 and the start time t5 of the non-emission period including the seventh period P7.

The end time t2 of the first period P1 may be the same as the end time t2 of an eighth period P8. In addition, the last toggle time t2 of the third sub-gate signal GI in the display scan period (DISPLAY SCAN) may be the same as the last toggle time t2 of the third sub-gate signal GI in the self-scan period (SELF SCAN).

That is, a length of a period P5 between the end time t2 of the first period P1 and the end time t6 of the non-emission period including the first period P1 may be the same as a length of a period P6 between the end time t2 of the eighth period P8 and the end time t6 of the non-emission period including the eighth period P6.

In FIG. 11, it is explained that the number of times the third sub-gate signal GI is supplied in the display scan period (DISPLAY SCAN) is 2, and the number of times that the third sub-gate signal GI is supplied is 1 in the self-scan period (SELF SCAN), but embodiments according to the present disclosure are not limited thereto.

As described in FIG. 10 and FIG. 11, the number of times the third sub-gate signal GI is supplied during the self-scan period (SELF SCAN) is different from that of the third sub-gate signal GI during the display scan period (DISPLAY SCAN), so that the phenomenon described in FIG. 7 may be prevented or reduced.

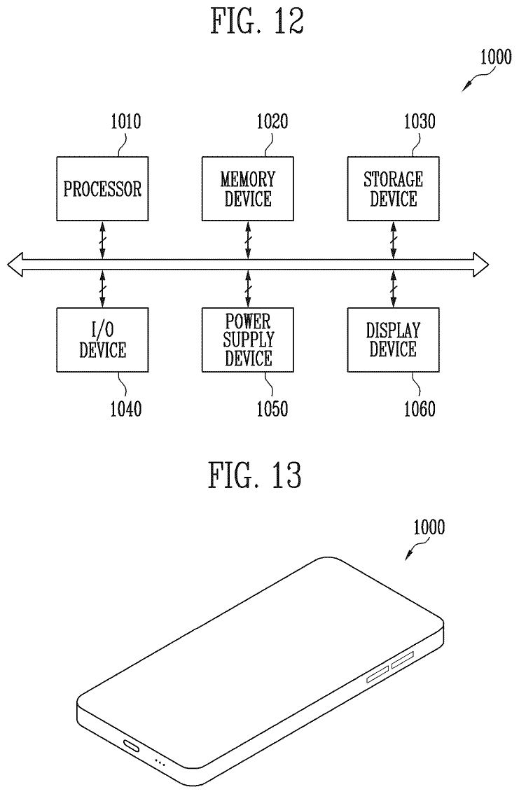

FIG. 12 is a block diagram illustrating an electronic device according to embodiments. FIG. 13 is a diagram illustrating an example in which the electronic device of FIG. 12 is implemented as a smartphone.

Referring to FIGS. 12 and 13, the electronic device 1000 may include a processor 1010, a memory device 1020, a storage device 1030, an input/output device 1040, a power supply device 1050, and a display device 1060. The display device 1060 may be the display device 100 of FIG. 1. In addition, the electronic device 1000 may further include various ports capable of communicating with a video card, a sound card, a memory card, a USB device, or the like, or communicating with other systems. According to some embodiments, as shown in FIG. 13, the electronic device 1000 may be implemented as a smartphone. However, this is an example, and the electronic device 1000 is not limited thereto. For example, the electronic device 1000 may be implemented as a mobile phone, a video phone, a smart pad, a smart watch, a tablet PC, a vehicle navigation system, a computer monitor, a notebook, a head mounted display device, or the like.

Processor 1010 may perform certain calculations or tasks. According to some embodiments, the processor 1010 may include a microprocessor, a central processing unit, an application processor, or the like. The processor 1010 may be connected to other components through an address bus, a control bus, a data bus, and the like. According to some embodiments, the processor 1010 may also be connected to an extension bus such as a Peripheral Component Interconnect (PCI) bus.

The display device 1060 may display an image in pixels (or sub-pixels) under the control of the processor 1010. According to some embodiments, the processor 1010 may generate the image data IMG of FIG. 1 and the control signal CTRL of FIG. 1 for controlling display thereof.

The memory device 1020 may store data necessary for the operation of the electronic device 1000. For example, the memory device 1020 may include a non-volatile memory device such as an Erasable Programmable Read-Only Memory (EPROM) device, an Electrically Erasable programmable Read-only Memory (EEPROM) device, a flash memory device, a Phase Change Random Access Memory (PRAM) device, a Resistance Random Access memory (RRAM) device, an Nano Floating Gate Memory (NFGM) device, a Polymer Random Access Memory (PoRAM) device, a Magnetic Random Access Memory (MRAM), a Ferroelectric Random Access Memory (FRAM) device, and/or a volatile memory device such as a Dynamic Random Access Memorial (DRAM) device, A Static Random access Memory (SRAM) device, or a mobile DRAM device.

The storage device 1030 may include a solid state drive (SSD), a hard disk drive (HDD), a CD-ROM, and the like.

The input/output device 1040 may include input means such as a keyboard, a keypad, a touchpad, a touch screen, a mouse, and the like, and output means such as a speaker, a printer, and the like. According to some embodiments, the display device 1060 may be included in the input/output device 1040.

The power supply device 1050 may supply power necessary for the operation of the electronic device 1000. For example, the power supply device 1050 may be a power management integrated circuit (PMIC).

The display device 1060 may display an image corresponding to visual information of the electronic device 1000. In this case, the display device 1060 may be an organic light emitting display device or a quantum dot light emitting display device, but embodiments according to the present disclosure are not limited thereto. The display device 1060 may be connected to other components via the buses or other communication links.

A display device according to some embodiments may minimize or reduce unintended images or image characteristics such as mura from being displayed by differentiating a waveform of a sub-gate signal supplied during a display scan period and a waveform of the sub-gate signal provided during a self-scan period from each other.

However, the characteristics of embodiments according to the present disclosure are not limited to the characteristics described above, and may be variously extended without departing from the spirit and scope of embodiments according to the present disclosure.

Embodiments should not be limited to the contents described in the detailed description of the specification, but should be determined by the claims. All modifications or variations derived from the meaning and scope of the claims, and their equivalents, are to be construed as included within the scope of the disclosure.

What is claimed is:

1. The display device comprising:
a sub-pixel connected to a data line, a first sub-light emission control line, a first sub-gate line, and a second sub-gate line, and including a light-emitting element;
a gate driver configured to supply a first sub-light emission control signal to the first sub-light emitting control line, to supply a first sub-gate signal to the first sub-gate line, and supply a second sub-gate signal to the second sub-gate line; and
a data driver configured to supply a data voltage to the data line,
wherein a length of a period in which the second sub-gate signal is supplied during a display scan period is different from a length of a period in which the second sub-gate signal is supplied during a self-scan period; and
wherein the second sub-gate signal is provided to control a time at which an electrode of the light-emitting element is initialized.

2. The display device of claim 1, wherein the sub-pixel comprises:
a first transistor configured to control driving current, the first transistor coupled between a first node which receives a first power supply voltage and a second node and including a gate electrode coupled to a third node;
a second transistor connected between the data line and the third node and including a gate electrode connected to the first sub-gate line;
a third transistor connected between the second node and a fourth node, and including a gate electrode connected to the first sub-light emission control line; and
a fourth transistor connected between a node configured to provide an initialization voltage and the fourth node, and including a gate electrode connected to the second sub-gate line,
wherein the light-emitting element is connected between the fourth node and a node which receives a second power supply voltage.

3. The display device of claim 2, wherein the data voltage is written to the sub-pixel during the display scan period, and the data voltage is not written to the sub-pixel during the self-scan period.

4. The display device of claim 3, wherein:
during the display scan period, the gate driver is configured to supply the second sub-gate signal for a first period; and
during the self-scan period, the gate driver is configured to supply the second sub-gate signal for a second period.

5. The display device of claim 4, wherein a length of the first period is longer than a length of the second period.

6. The display device of claim 5, wherein a length between an end time of a non-emission period including the first period and an end time of the first period is the same as a length between an end time of a non-emission period including the second period and an end time of the second period.

7. The display device of claim 6, wherein a length between a start time of the non-emission period including the first period and a start time of the first period is shorter than a length between a start time of the non-emission period including the second period and a start time of the second period.

8. The display device of claim 4, wherein a length of the first period is shorter than a length of the second period.

9. The display device of claim 8, wherein a length between an end time of a non-emission period including the first period and an end time of the first period is the same as a length between an end time of a non-emission period including the second period and an end time of the second period.

10. The display device of claim 9, wherein a length between a start time of the non-emission period including the first period and a start time of the first period is longer than a length between a start time of the non-emission period including the second period and a start time of the second period.

11. The display device of claim 5, wherein the sub-pixel further comprises:
a fifth transistor connected between a node configured to receive the first power supply voltage and the first node, and including a gate electrode connected to a second sub-light emission control line; and
a sixth transistor connected between a node configured to receive a reference voltage and the third node, and including a gate electrode connected to a third sub-gate line, and
wherein the gate driver is configured to supply a second sub-light emission control signal to the second sub-light emitting control line, and to supply a third sub-gate signal to the third sub-gate line.

12. The display device comprising:
a sub-pixel connected to a data line, a first sub-light emission control line, a first sub-gate line, and a second sub-gate line and including a light-emitting element;
a gate driver configured to supply a first sub-light emission control signal to the first sub-light emitting control line, to supply a first sub-gate signal to the first sub-gate line, and supply a second sub-gate signal to the second sub-gate line; and
a data driver configured to supply a data voltage to the data line;
wherein a number of times that the second sub-gate signal is supplied during a display scan period is different from a number of times the second sub-gate signal is supplied during the self-scan period; and
wherein the second sub-gate signal is provided to control a time at which an electrode of the light-emitting element is initialized.

13. The display device of claim 12, wherein the sub-pixel comprises:
a first transistor configured to control driving current, the first transistor coupled between a first node which receives a first power supply voltage and a second node and including a gate electrode coupled to a third node;
a second transistor connected between the data line and the third node, and including a gate electrode connected to the first sub-gate line;
a third transistor connected between the second node and a fourth node, the third transistor including a gate electrode connected to the first sub-light emission control line; and
a fourth transistor connected between a node configured to provide an initialization voltage and the fourth node, the fourth transistor including a gate electrode connected to the second sub-gate line,
wherein the light-emitting element is connected between the fourth node and a node which receives a second power supply voltage.

14. The display device of claim 13, wherein the data voltage is written to the sub-pixel during the display scan period, and the data voltage is not written to the sub-pixel during the self-scan period.

15. The display device of claim 14, wherein a number of times the gate driver supplies the second sub-gate signal during the display scan period is less than a number of times the gate driver supplies the second sub-gate signal during the self-scan period.

16. The display device of claim 14, wherein a number of toggles of the second sub-gate signal during the display scan period is less than a number of toggles of the second sub-gate signal during the self-scan period.

17. The display device of claim 16, wherein a number of toggles is a number of times a logic level of the second sub-gate signal changes.

18. The display device of claim 14, wherein a number of times the gate driver supplies the second sub-gate signal during the display scan period is greater than a number of times the gate driver supplies the second sub-gate signal during the self-scan period.

19. The display device of claim 15, wherein the sub-pixel further comprises:
a fifth transistor connected between a node configured to receive the first power supply voltage and the first node, and including a gate electrode connected to a second sub-light emission control line; and
a sixth transistor connected between a node configured to receive a reference voltage and the third node, and including a gate electrode connected to a third sub-gate line,
wherein the gate driver is configured to supply a second sub-light emission control signal to the second sub-light emitting control line, and is configured to supply a third sub-gate signal to the third sub-gate line.

20. An electronic device comprising:
a processor; and
a display device including pixels, and configured to display an image in the pixels under a control of the processor;
the display device comprises:
a sub-pixel connected to a data line, a first sub-light emission control line, a first sub-gate line, and a second sub-gate line, and including a light-emitting element;
a gate driver configured to supply a first sub-light emission control signal to the first sub-light emitting control line, to supply a first sub-gate signal to the first sub-gate line, and to supply a second sub-gate signal to the second sub-gate line; and
a data driver configured to supply a data voltage to the data line,
wherein a length of a period in which the second sub-gate signal is supplied during a display scan period is different from a length of a period in which the second sub-gate signal is supplied during a self-scan period; and
the second sub-gate signal is provided to control a time at which an electrode of the light-emitting element is initialized.
